(19) United States
(12) Patent Application Publication
(10) Pub. No.: US 2012/0305018 A1
(43) Pub. Date: Dec. 6, 2012

(54) Method for cutting hair and apparatus for use therein

(76) Inventor: Lara De Donno, Rheinfelden (CH)

(21) Appl. No.: 13/506,967

(22) Filed: May 29, 2012

(30) Foreign Application Priority Data
May 26, 2011 (CH) 00901/11
May 16, 2012 (CH) 00696/12

(51) Int. Cl. B26B 13/20; B26B 13/22; A45D 24/36

(52) U.S. Cl. 132/200; 132/213.1; 30/123; 30/233.5

(57) ABSTRACT

Proposed is a method for forming curly or wavy hairstyle. A chunk of hair (1) is in each case formed by means of a comb (20) and is held tightly away from the head between two fingers (7). Scissors (2) are guided to the cutting point (3) and a sliding movement (9″) and a closing movement (9′) are now carried out by means of the scissors (2), and a leveling curve-shaped cutting line (8) from the cutting point (3) to the fingers (7), which hold the chunk of hair (1), are thus carried out. Preferably, hairdresser scissors (30) comprising an open eye (36) for the thumb and a comb (20), which encompasses an optically visible separation (22, 23), is used hereby.

The instant invention relates to a method for cutting hair according to the preamble of patent claim 1, as well as to means for more easily carrying out the method according to claim 1.

The formation of locks of hair can be caused genetically or, as has been known for many years, can be obtained under the influence of heat, as was done in the past by means of curling irons and later with the help of curlers. In addition to thermal influences, chemical processing methods have also become known of late, which cause a curling of the hair.

It has already been known for a long time to create curls by means of the haircut. This is based on the fact that shorter hair sticks away from the scalp in a virtually straight manner due to its own low weight, as is known in the case of short haircuts, in particular for men. In the event that the hair has different lengths in the case of a single strand of hair, the shorter hair acts as a support and the longer hair falls over them while simultaneously forming curls.

This technology is used in particular in the case of the so-called “bob” to obtain the curly hair, which falls inwards in the area close to the neck.

A method for cutting hair for creating curly or wavy hairstyles, in the case of which a chunk of hair is grabbed between the fingers of the one hand approximately vertically to the shape of the parallel hair and the open scissors are then inserted with the other hand at an angle or vertically to the direction of the chunk of hair is already known from EP 0864774 B. In response to a simultaneous, even rotation of the scissors about an axis vertically to the plane formed by the strand of hair, a strand of hair is then passed up to a cutting angle α, so that a curved cut is created with substantially the same cutting radius. This procedure is then carried out several times for each chunk of hair. The cutting of a strand of hair in response to an even rotation about an axis of rotation does not correspond to the typical course of movement, because the hairdresser for the most part creates the haircut while moving the scissors away from the head of the client, while this takes place vice versa here. To be able to carry out this unfamiliar movement, EP 864774 proposes scissors, which encompass a guide element comprising a recess-like indentation, in which a fingertip comes to rest and the rotary motion of the scissors about a fixed axis can thus take place. In addition to the movement, with which the hairdresser is unfamiliar, there is also a danger of injury to the client in the case of shorter hair in response to the movement towards the scalp of the client. In addition, the same radius is always obtained in the case of this known hair cutting method, simply due to the guide element and the rotation about a fingertip, which, however, limits the creative freedom of the hairdresser.

It is thus the object of the instant invention to obtain an improved, safe method for cutting hair for obtaining a smooth, curly hairstyle, using scissors, whereby, as is known, the following steps are carried out:

a) forming an uncut chunk of hair by means of a comb and holding a chunk of hair between the two adjacent fingers of one hand approximately vertically to the shape of the parallel hair, which is held tightly away from the scalp and then

b) the open scissors are inserted with the other hand at an angle or vertically to the shape of the hair of the chunk of hair, which is held.

This object is fulfilled in that, after the two above-mentioned method steps have been carried out, the following steps according to the invention are carried out:

c) the scissors are moved so as to slide from a cutting point, away from the fingers, which hold the chunk of hair, in the direction of the fingers holding the chunk of hair and a closing movement of the scissors is carried out at the same time, namely such that

d) the cutting line runs at least approximately vertically towards the fingers in a curve, which levels off, starting at the cutting point, wherein

e) more than one cutting line is carried out for each chunk of hair.

Further advantageous alternatives of the method according to the invention follow from dependent patent claims 2 to 5.

Means according to the invention for carrying out the method according to the invention are furthermore proposed. Preferably, these means consist of at least one pair of hairdresser scissors according to the invention, which is suitable in particular for the course of movement required here and which is characterized by the features according to patent claim 6. It can furthermore be advantageous to use a comb, which is provided with an optically visible separation for the cuts, which are to be applied for each chunk of hair. It thus becomes visible to the hairdresser, from where at the cutting point, the leveling, curved cut is to end.

In the drawings

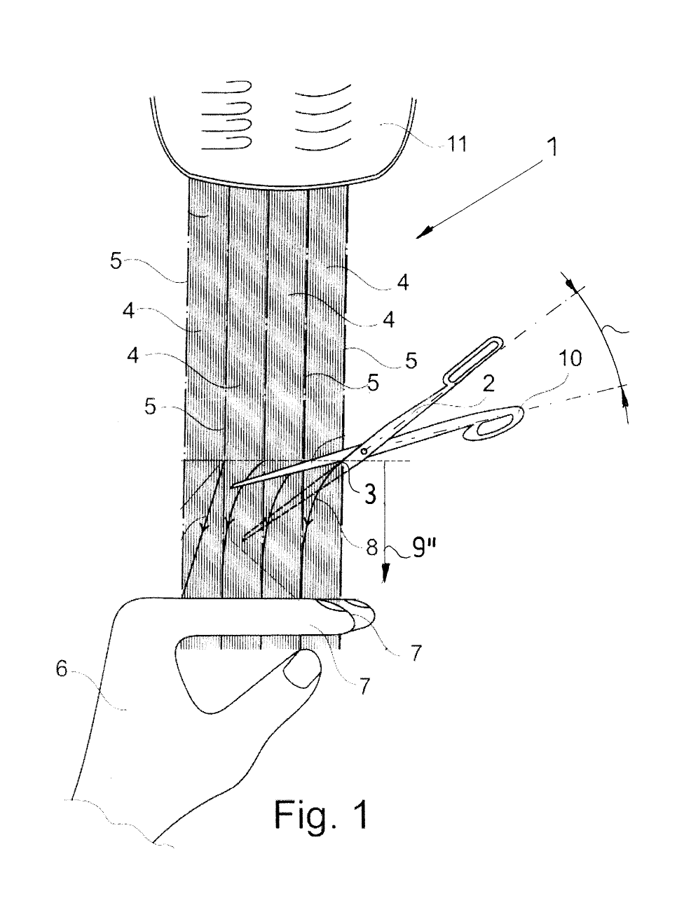

FIG. 1 shows, schematically, the cutting pattern according to the method and

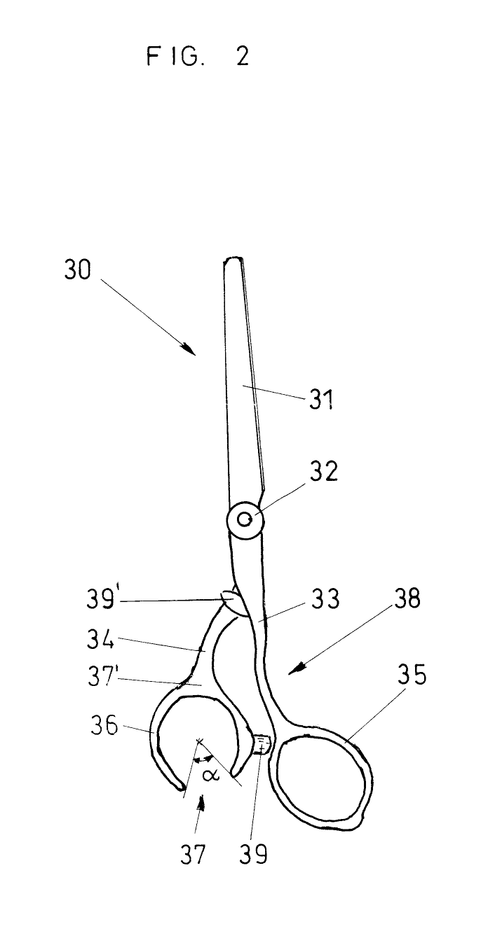

FIG. 2 shows a pair of hairdresser scissors, which is particularly suitable for the method and

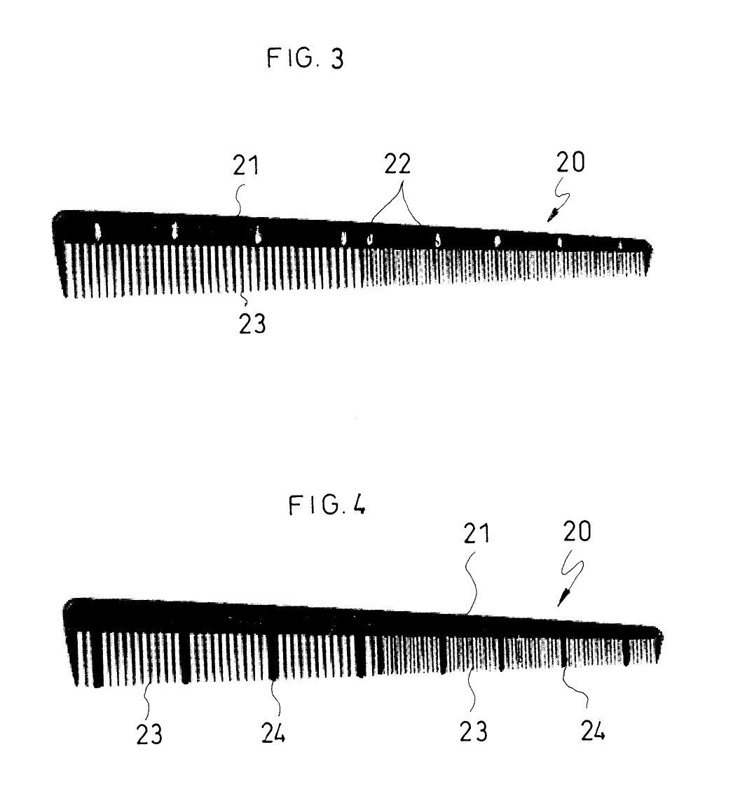

FIGS. 3 and 4 show two different embodiments of a comb.

In the event that the hairdresser wants to cut the hair of a client according to the instant method so as to obtain a smooth, curly hairstyle, he will use a pair of hairdresser scissors for this purpose as usual. It is indeed also possible hereby to carry out this method by means of a common pair of hairdresser scissors and a common comb. By means of a comb 20, the hairdresser forms an uncut chunk of hair 1 as usual and holds this chunk of hair 1 between two adjacent fingers 7 of one hand 6, so that the hair runs parallel and slightly vertically to the stretched fingers 7. The hair is to thereby be held relatively tightly away from the scalp 11. A chunk of hair refers to the totality of hair, which is held between the two fingers 7. Depending on the width of the chunk of hair, which is held, the hairdresser separates this chunk of hair into approximately 2-4 strands 4 either mentally or with the help of a comb. He how moves the open scissors 2 at an angle or vertically to the orientation of the hair of the held chunk of hair 1 into such a strand 4 and now moves the scissors so as to slide 9″ in the direction of the fingers 7, which hold the chunk of hair 1. During this sliding movement 9″, he simultaneously carries out a closing movement 9′ with the scissors. He will thereby coordinate the sliding movement 9″ and the closing movement 9′ such that the cutting line 8 runs approximately in a parabolic curve, starting at the cutting point to the fingers, wherein the curve levels off such that it runs approximately vertical towards the fingers 7 in the end area of the curve. The description of the cutting line 8 as being approximately parabolic suggests that the cutting point virtually forms the apex of the parabola and the cutting line 8 thus only forms approximately half a parabolic line. The cutting line 8 could also be described as a quarter of an elliptical circumferential line, wherein the cutting point would correspond to that point of the ellipsis, in which the longer diagonal ends and the end of the cutting line 8 is located where the shorter diagonal of the ellipsis ends. It goes without saying that this descriptive information only serves to describe the course of the cutting line. It goes without saying that the hairdresser is not able to obtain an accurate parabolic curve or an accurate elliptical partial curve by means of the scissors and the descriptions provided herein are to only specify that the cutting line is a curve, which starts with a narrow radius and that the radius of curvature then increases continuously and finally ends virtually in a straight line. Overall, a change of direction by approx. 90° takes place hereby. However, to describe this curve, the hairdresser does not need to pivot the scissors. As is known, any curve can be obtained by means of the corresponding coordination of closing movement 9′ and sliding movement 9″ of the scissors 2.

2-4 of such cutting lines 8 are carried out, depending on the width of the captured chunk of hair 1.

As mentioned above, the cutting line 8 can only be obtained by means of the coordination of a sliding movement 9″ and a closing movement 9′ of the scissors. However, it might be easier for some hairdressers when he also passes the scissors during the sliding movement 9″ into a pivot movement away from the head of the client towards the fingers 7, which hold the chunk of hair 1. Some hairdressers also use the hand, with which they hold the chunk of hair 1, to also hold the comb 20, which now virtually lies like a shield in front of the fingers 7, which hold the chunk of hair 1. This also protects the fingers of the hairdresser.

On principle, the desired curve of the cutting line 8 can be obtained in that the speed of the closing movement 9′ of the scissors 2 is allowed to decrease during the sliding movement 9″ from the cutting point 3 to the end of the cutting line 8, while the speed of the sliding movement 9″ is maintained at the same time. This is simpler than maintaining the speed of the closing movement 9′ and to instead increase the speed of the sliding movement 9″. In the alternative, however, the hairdresser can also maintain the speed of the closing movement 9′ and the speed of the sliding movement 9″ to both be the same, while the hairdresser additionally pivots the scissors 2 away from the head 10 of the client towards the fingers 7, which hold the chunk of hair 1. The selection of which movement to perform lies with the hairdresser. Only the result, namely the cutting line 8, which is to be obtained, is important.

The method according to the invention requires the hairdresser to carry out an unfamiliar rotation of the hand. Typically, the hairdresser holds the scissors such that the thumb rests in one eye and the ring finger rests in the other eye, while index finger and middle finger are located on that leg of the scissors, on which the eye is integrally molded, in which the ring finger is inserted. While the ring finger is typically relatively thin, it can follow the pivot movement in the eyelet without any problems. The thicker thumb, however, always hits the rear eye of the scissors in response to this pivot movement. This is bothersome and can lead to corresponding discomfort after a longer period of time. Accordingly, specially designed scissors are proposed as means for carrying out the hair cutting method according to the invention. A correspondingly designed comb is preferably furthermore used as an additional means. However, the hairdresser scissors will be described for the time being.

FIG. 2 illustrates scissors, which are particularly well suited for the method according to the invention. Scissors consist of two scissor blades, which are connected to one another by means of a so-called lock so as to be capable of being pivoted. The hairdresser scissors as a whole is identified here with 30 and the scissor blades with 31 and the closure with 32. The extension of a scissor blade merges into a leg 33 and the other scissor blade merges into a leg 34. Eyeless, which are called eyes in the technical language, are integrally molded on the end of these legs 33 and 34. These eyes are identified with 35 and 36. The ring finger eye 35 is integrally molded on the longer leg 33, while the thumb eye 36 is integrally molded on the shorter leg 34. According to the invention, the thumb eye 36 has an opening 37. This opening is located on the rear end, thus at the location, which is located opposite to the connection 37′. The thumb eye 36 is connected to the shorter leg 34. Optionally, a buffer 39 is attached to the open thumb eye 36 and a pivotable stop 39′ can be arranged in the area, in which the two legs 33 and 34 diverge to limit the closing movement of the scissors. These elements are indeed known in the case of hairdresser scissors. Albeit having a completely different shape, the design of the longer leg 33 is also known. This longer leg 33 often runs so as to be curved such that a contact recess 38 is created here, which is dimensioned such that ring finger and index finger can rest here.

In spite of the asymmetric design of the hairdresser scissors, this does not demand that scissors must be made specifically for left-handers or right-handers, because the hairdresser scissors can be used for left-handers or for right-handers, depending on whether the scissors are held such that the screw end of the lock 32 or the head-side end of the lock is located on the top.

The open eye 36, which is also called thumb eye here, has a c-shaped design. The opening of the eye can be approximately one-fourth to one-third of the circumference. Due to the fact that the shape of the eye is not round, an opening angle a is defined here, which is drawn by straight lines from the center to the ends of the openings. This angle a lies between 30° and 120°. This depends highly on the size of the eye 36.

As already mentioned, the hairdresser uses a comb for forming the chunk of hair 1. He guides this comb with the one hand, while he holds the chunk of hair 1 between two adjacent fingers 7 with the other hand. He can now pass the comb, which he holds in the one hand, to the other hand, so that the comb is located in front of index finger and middle finger, for example, which hold the chunk of hair 1, while he holds the comb at the same time with the remaining fingers 7. Hairdressers already use this technique today as well. So as to now facilitate the desired separation 5 into the corresponding strands 4, a comb 20, which is specifically designed for this purpose, can encompass means, which are optically visible and which provide for this separation. Such means can be designed in different ways. In the simplest way, corresponding separating lines 22 can be attached to the back of the comb 21. These separating lines 22 run to the corresponding teeth 23 of the comb 20.

Another possibility is for the comb 20 to encompass a considerably thicker toot 24 at even distances, whereby a gap is automatically created in the chunk of hair 1. A concrete separation 5 of the chunk of hair 1 into the desired strands 4 is carried out through this. He can push those hairs, which only fill a part of a strand, to the side, so that they are no longer captured and the desired cutting point 3 of the cutting line 8 is now located freely in front of him. It goes without saying that it is also possible to optically mark a comb 20 such that every eighth tooth, for example, is designed so as to differ in color from the remaining teeth. This also leads to separation of the chunk of hair 1, which is clearly visible. Due to the fact that the hairdresser can freely choose the cutting point 3 in any case, it is comfortable for him to have the end point of the cutting line 8 in front of him in a clearly visible manner. Thanks to the comb according to the invention, the hairdresser can thus carry out the method according to the invention more easily.

### LIST OF REFERENCE NUMERALS

1 chunk of hair

2 scissors

3 cutting point

4 strand

5 strand separation

6 hand

7 fingers

8 cutting line

9′ closing movement of the scissors

9″ sliding movement of the scissors

10 head

20 comb

21 back of comb

22 separating line

23 teeth

24 thick tooth

30 hairdresser scissors

31 scissor blades

32 lock

33 longer leg

34 shorter leg

35 ring finger eye

36 thumb eye

37 opening

37′ connection

38 contact recess

39 buffer

39′ pivotable stop

1: A method for cutting hair for obtaining a smooth, curly hairstyle, using scissors, wherein the following steps are carried out;
a) forming an uncut chunk of hair by means of a comb and holding the chunk of hair between two adjacent fingers of a hand approximately vertically to the shape of the parallel hair, which is held tightly away from the scalp;
b) inserting the open scissors with the other hand at an angle or vertically to the shape of the hair of the chunk of hair, which is held;
c) moving the scissors so as to slide from a cutting point, away from the fingers, which hold the chunk of hair in the direction of the fingers which hold the chunk of hair (1), and at the same time carrying out a closing movement of the scissors such that
a leveling curve-shaped cutting line runs from the cutting point so as to level out at least approximately vertically to the lingers, wherein
more than one cutting line is carried out for each chunk of hair.

2: The method according to claim 1, wherein, in step c), the hairdresser carries out a pivot movement away from the head of the client towards the fingers, which hold the chunk of hair, during the sliding movement.

3: The method according to claim 1, wherein, in step c), the speed of the closing movement of the scissors remains the same, while the speed of the sliding movement decreases from the cutting point to the end of the cutting line.

4: The method according to claim 2, wherein, in step c), the speed of the closing movement and the speed of the sliding movement of the scissors are linear and the hairdresser at the same time pivots the scissors away from the head of the client and towards the lingers, which hold the chunk of hair.

5: The method according to claim 1, wherein, 2-4 cuts are applied for each chunk of hair.

6: A system for carrying out the method according to claim 1, the device comprising at least one pair of hairdresser scissors, consisting of two scissor blades, which are connected to one another in an articulated manner by means of a lock and which merge into legs, each comprising its own eye, wherein one of the two eyes is open on the area located opposite the connection of this eye on the leg, so that the eye is designed in a c-shaped manner.

7: The system according to claim 6, wherein the open eye encompasses an opening angle α of 30° to 120°.

8: The system according to claim 6, wherein the system, further comprises a comb, which is provided with an optically visible separation tor the cuts, which are to be applied for each chunk of hair.

9: The system according to claim 8, wherein the separation is visible on the back, of the comb by means of separating lines.

10: The system according to claim 8, wherein the separation is carried out by means of thicker teeth, which are visible as compared to the remaining teeth.

11: The system according to claim 8, wherein the separation is carried out by means of teeth, which are marked in color.
